(19) United States
(12) Patent Application Publication
(10) Pub. No.: US 2025/0335811 A1
(43) Pub. Date: Oct. 30, 2025

(54) NOISE ADDITION FOR DIFFERENTIAL PRIVACY WITH PRESERVATION OF DATA UTILITY

(71) Applicant: Palo Alto Networks, Inc., Santa Clara, CA (US)

(72) Inventors: Sannisth Amitkumar Soni, San Jose, CA (US); Anirudh Mittal, Fremont, CA (US); Sujit Rokka Chhetri, San Jose, CA (US)

(21) Appl. No.: 18/646,561

(22) Filed: Apr. 25, 2024

(51) Int. Cl. G06N 20/00; G06F 21/55

(52) U.S. Cl. CPC G06N 20/00; G06F 21/554; G06F 2221/034

(57) ABSTRACT

Noise is added to data obtained from customers for differential privacy without reducing utility of the data for downstream use and/or analysis, such as data obtained from data loss prevention (DLP) services that are used for ongoing learning of DLP models. Noise is added to an N-dimensional text embedding(s) based on scaling values contained in the text embeddings on a per-dimension basis. For each dimension of the embedding(s), the corresponding value at that dimension is scaled based on minimum and maximum values that are localized to that dimension and were previously selected based on experimental data for which embeddings were generated. Noise is added to the resulting embeddings that have been scaled per dimension, such as with the Laplace mechanism.

### BACKGROUND

The disclosure generally relates to security arrangements for protecting computers, components thereof, programs or data against unauthorized activity (e.g., CPC subclass G06F 21/00) and to protecting data (e.g., CPC subclass G06F 21/60).

Additive noise techniques involve adding noise to data in a controlled manner. Adding noise to data has applications in differential privacy, which includes the addition of noise to data to preserve the privacy of entities (e.g., individuals and/or organizations) represented in the data, such as data that comprise personally identifiable information (PII) or otherwise sensitive information. Noise addition entails adding random variability, or noise, to data to reduce the ability of third parties to infer information about entities from the data. Noise addition is controlled in part by an epsilon (ε) parameter, which indicates the amount of noise to be introduced to data. The ability to deduce the original, de-noised data from added noise data decreases with decreasing values of epsilon, with an epsilon value of zero corresponding to a maximum amount of added noise.

Data loss prevention (DLP) tools are used by organizations to prevent the unauthorized or unsafe exposure of data to those outside of the organization. DLP tools work to prevent loss of data by monitoring data in motion, data in use, and data at rest (collectively “data”). Data in motion refers to data that is actively in transit (e.g., over a network) between locations. Data in use refers to data being accessed, processed, or otherwise manipulated in memory. Data at rest refers to data in storage that is not actively in transit or being accessed.

### BRIEF DESCRIPTION OF THE DRAWINGS

Embodiments of the disclosure may be better understood by referencing the accompanying drawings.

FIG. 1 is a conceptual diagram of adding noise to data obtained from end users for differential privacy in the context of DLP.

FIG. 2 is a flowchart of example operations for adding noise to data obtained from an end user(s) for differential privacy.

FIG. 3 is a flowchart of example operations for adding noise to data indicated for DLP scanning.

FIG. 4 is a flowchart of example operations for determining minimum and maximum values per dimension for scaling of embeddings.

FIG. 5 depicts an example computer system with a noise addition service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Organizations may want to store data obtained from customers for subsequent use and/or analysis but without the risk of the customer's data being exposed in the event of a breach or unauthorized access. While noise addition for differential privacy does exist, techniques may reduce downstream utility of the data (e.g., may reduce accuracy in classification of the data), and it is possible to reverse engineer the data with noise added using conventional techniques. One instance where this may be the case is in the field of DLP. DLP services often employ machine learning techniques to predict whether data are sensitive. Data obtained from customers can be used for ongoing learning of DLP models, though maintaining privacy of the data that is retained for ongoing learning may be a concern, particularly in the case where sensitive data are obtained from the customers.

Disclosed herein are techniques by which noise is added to data obtained from customers for differential privacy without reducing utility of the data for downstream use and/or analysis, such as data obtained from DLP services that are used for ongoing learning of DLP models. A noise addition service adds noise to a dataset comprising one or more N-dimensional text embeddings based on scaling values contained in the text embeddings on a per-dimension basis. This is in contrast to conventional noise addition techniques, where data are scaled based on global maximum and minimum values determined across all dimensions in the dataset. For each dimension of an embedding designated for noise addition, the corresponding value at that dimension is scaled based on minimum and maximum values that are localized to that dimension. The minimum and maximum values per dimension have been determined based on experimental data for which embeddings were generated. The service then adds noise to the resulting embeddings that have been scaled per dimension, such as with the Laplace mechanism. The “noisy” dataset that results thus obscures any PII or otherwise sensitive data included in the original dataset but without accuracy in classification ability being compromised due to the scaling being localized per dimension rather than global across dimensions. Experimental results show tangible improvement in classification of sensitive data by DLP services that process the data having noise added with the disclosed technique instead of with conventional techniques where scaling is performed based on globally identified minimum and maximum values rather than minimum and maximum values per dimension. For example, classification on United States driver's license data saw a 18.6% improvement between noise-added driver's license data with conventional techniques and with the disclosed technique. Similarly, United Kingdom passport data has seen a 7.5% improvement in classification, United States passport data has seen a 9.6% improvement, and social security number data has seen a 14.2% improvement.

### Example Illustrations

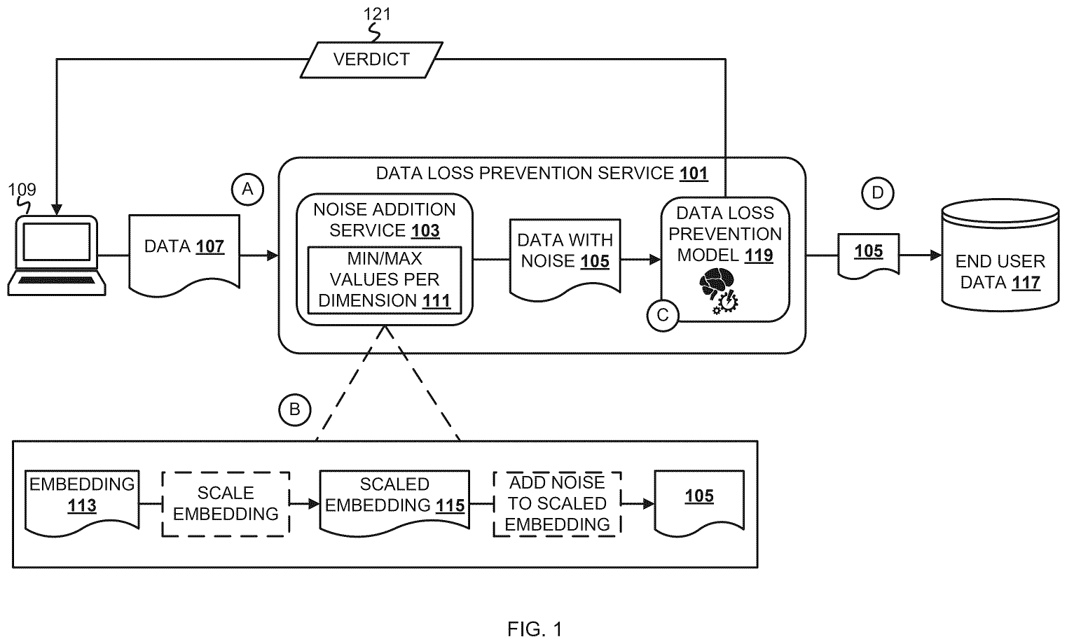

FIG. 1 is a conceptual diagram of adding noise to data obtained from end users for differential privacy in the context of DLP. FIG. 1 depicts a noise addition service (“the service”) 103 that is part of a data loss prevention service (“the DLP service”) 101. The DLP service 101 may execute as part of a cybersecurity appliance (e.g., a firewall). The service 103 executes as part of the DLP service 101 in this example to depict an application of the service 103 to DLP operations, though the service 103 can execute in other contexts. For instance, the service 103 can execute as a standalone service on a physical or virtual server or as part of another application or service that obtains data designated for noise addition.

FIG. 1 is annotated with a series of letters A-D. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the DLP service 101 obtains data 107 from a client 109. The data 107 comprise data being updated, transmitted, etc. by the client 109 that may comprise sensitive information and is thus subject to DLP scanning by the DLP service 101. For instance, the data 107 may be textual data and/or may comprise numerical features. As an example, the data 107 may be data transmitted by the client 109 that the DLP service 101 intercepts or data stored at the client 109 that is being accessed/updated. The DLP service 101 designates the data 107 for DLP scanning to inform whether the data 107 comprise sensitive information and thus whether the update, transmission, etc. by the client 109 should be permitted. The DLP service 101 generates an embedding 113 representing the data 107 for the DLP scan. The DLP service 101 can generate the embedding 113 with word2vec, doc2vec, or another text embedding technique by which text embeddings are generated. This example assumes that the DLP service 101 generates embeddings and inputs the embeddings into the service 103, though in implementations, the DLP service 101 can pass data as input to the service 103 for generation of a corresponding embedding by the service 103.

At stage B, the service 103 adds noise to the embedding 113 of the data 107 based on minimum and maximum values per dimension 111. The minimum and maximum values per dimension 111 comprise values for each of N dimensions of embeddings that the DLP service 101 generates. The minimum and maximum values per dimension 111 can comprise a data structure(s) that stores each of the values and corresponding dimension, such as a data structure(s) with a length or size of N. The minimum and maximum value per dimension were previously selected based on experimental data. For instance, embeddings of a dataset of experimental data may have been generated, and for each dimension of embeddings in the dataset, a minimum value and maximum value at that dimension was determined across embeddings. The minimum and maximum values per dimension 111 with which the service 103 is configured thus comprise two values per dimension designated as a minimum value and a maximum value.

The service 103 scales the embedding 113 according to the minimum and maximum values per dimension 111 to generate a scaled embedding 115. Scaling of values per dimension of an embedding scales each value relative to a fixed range (e.g., from 0 to 1). To scale the embedding 113, the service 103 scales the value at each dimension of the embedding 113 relative to the corresponding ones of the minimum and maximum values per dimension 111. For instance, the scaled value at each dimension of the embedding 113 can be computed as (x−x_min)/(x_max−x_min), where x_min and x_max are the corresponding minimum and maximum values identified for the dimension in the minimum and maximum values per dimension 111. The resulting value may be negative if the value in the embedding 113 is greater than the corresponding maximum or less than the corresponding minimum. The scaled embedding 115 that results comprises, for each dimension, a value that has been scaled according to the minimum and maximum values localized to that dimension (i.e., the corresponding ones of the minimum and maximum values per dimension 111). The service 103 then adds noise to the scaled embedding 115 with a noise addition technique that promotes differential privacy to generate data with noise 105. Noise addition techniques for differential privacy generally add noise to data based on a probability distribution. The service 103 can utilize the Laplace mechanism to add noise to the scaled embedding 115, for instance. As another example, the service 103 can add Gaussian noise to the scaled embedding 115 to generate the data with noise 105. The service 103 may have been preconfigured with an epsilon (ε) value used as a parameter to the noise addition algorithm being used, such as an epsilon value of 10.

At stage C, the service 103 inputs the data with noise 105 into a trained DLP model 119. The trained DLP model 119 is a model that has been trained to predict whether data provided as input are sensitive. Often, the trained DLP model 119 is a trained classifier (e.g., a trained neural network, a trained random forest classifier, etc.), where class predictions indicate whether the data are predicted to comprise sensitive information (e.g., PII). The trained DLP model 119 may have previously been trained on embeddings with noise added by the service 103, embeddings without noise added that have been scaled relative to the minimum and maximum values per dimension 111, or a combination thereof. The trained DLP model 119 outputs a verdict 121 indicating whether the data with noise 105 and thus the data 107 being represented by the data with noise 105 are predicted to comprise sensitive information. While not depicted in this example for clarity, the DLP service 101 can perform an additional action(s) based on the verdict 121, such as blocking transmission, update, etc. of the data 107 if the data 107 are predicted to be sensitive or allowing transmission, update, etc. of the data 107 if the data 107 are not predicted to be sensitive.

At stage D, the DLP service 101 stores the data with noise 105 in a database 117 that stores end user data. The DLP service 101 can store the data with noise 105 in addition to the verdict 121 associated therewith in the database 117. The database 117 is maintained by a provider of the DLP service 101 and the service 103, such as a cybersecurity provider. Because the data with noise 105 comprise an obscured representation of the original embedding of the data 107 (i.e., the embedding 113) that has been generated with the technique implemented by the service 103, the provider can store data obtained from end users with substantially minimized risk of sensitive end user data being exposed in the event of a breach or unauthorized access.

While not depicted in FIG. 1, embeddings with noise added thereto that are maintained in the database 117 can be utilized for ongoing learning/incremental training of the trained DLP model 119. For instance, embeddings and their corresponding predicted classes can be retrieved from the database 117 and added to a set of training data used for incremental training of the DLP model 119. Incremental training with embeddings having noise added according to the technique implemented by the service 103 reinforces the abilities of the DLP model 119 to classify embeddings having noise added by the service 103 and also provides additional training data obtained from end users without risking exposure of the end users' sensitive information. Alternatively, or in addition, embeddings with noise added that are maintained in the database 117 can be utilized for training of new DLP models. Embeddings can thus be retrieved from the database 117 to supplement training data sets used for ongoing learning of existing models and/or training of new models.

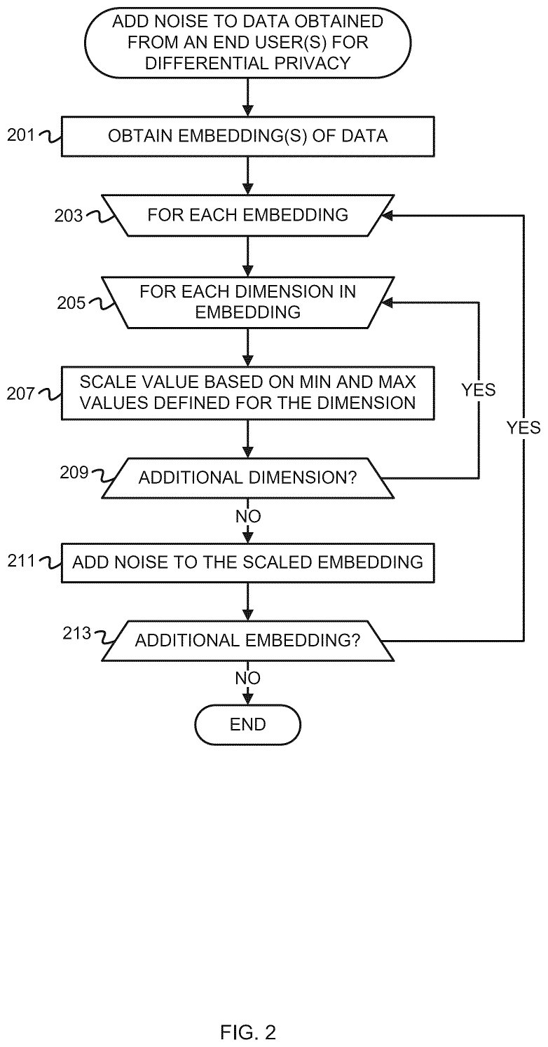

FIGS. 2-4 are flowcharts of example operations. The example operations are described with reference to a DLP service and a noise addition service for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for adding noise to data obtained from an end user(s) for differential privacy. The example operations are described with reference to the noise addition service.

At block 201, the noise addition service obtains one or more embeddings of data. The data may be textual and/or comprise numerical features, which may be scalars or vectors. The data can comprise data submitted by an end user, a data set obtained for one or more end users (e.g., data of a customer or one or more customers), etc. The embeddings may have been generated previously and provided to the noise addition service (e.g., by a DLP service that obtained the data) or the noise addition service may generate the embeddings upon obtaining the data. In the case of the latter, the noise addition service may generate the embeddings for each of the data (e.g., for each item of text) with a text embedding algorithm such as word2vec or doc2vec, for example.

At block 203, the noise addition service begins processing each embedding. The noise addition service processes a single embedding or each embedding in a dataset comprising a plurality of embeddings.

At block 205, the noise addition service begins iterating over each dimension in the embedding. The embedding comprises N dimensions, where each dimension of the embedding stores a numerical value. The example operations describe processing for each dimension individually for clarity, though dimensions of an embedding can be processed concurrently in implementations.

At block 207, the noise addition service scales the value at the dimension of the embedding based on maximum and minimum values defined for the dimension. Minimum and maximum values for each dimension were previously determined, such as based on experimental data, and the noise addition service is configured with these values per dimension. The noise addition service scales the value at the dimension to be relative to the corresponding minimum and maximum values, such as with the formula x_scaled=(x−x_min)/(x_max−x_min), where x is the value identified from the embedding, x_min is the minimum value defined for the dimension, x_max is the maximum value defined for the dimension, and x_scaled is the scaled value of x that the noise addition service computes. The minimum and maximum values may be stored in a data structure, where the index of the data structure corresponds to the associated dimension. The noise addition service determines the minimum and maximum values determined for the current dimension of the embedding and scales the value at that dimension relative to the determined minimum and maximum values.

At block 209, the noise addition service determines if there is another dimension to be scaled. If there is another dimension, operations continue at block 205. Otherwise, if there are no embeddings remaining and the collection of values in the embedding has thus been scaled, operations continue at block 211.

At block 211, the noise addition service adds noise to the scaled embedding. The noise addition service adds noise to the scaled embedding with a noise addition technique for differential privacy, such as by adding noise to the embedding according to a Laplace distribution or a Gaussian distribution with Laplace or Gaussian mechanisms, accordingly. The noise addition service may have been preconfigured with an epsilon value to be used as a parameter for the noise addition technique, such as a setting of ε=10. The noise addition algorithm may further accept as an input parameter a difference between the maximum and minimum values for each dimension. Since values have already been scaled, this parameter should correspond to the length of the interval relative to which values have been scaled (e.g., the value 1 when scaling is relative to the range of values between 0 and 1). The resulting embedding has had noise added thereto according to the noise addition technique. Additive noise mechanisms often refer to applying a function to data before adding noise, and the noise addition is scaled based on the sensitivity of the function (e.g., as is the case with the scale parameter of the Laplace mechanism). For noise addition to scaled embeddings, the noise can be added to the embedding itself without applying a function to the scaled embedding beforehand.

At block 213, the noise addition service determines if there is an additional embedding. If there is an additional embedding, operations continue at block 203. Otherwise, operations are complete.

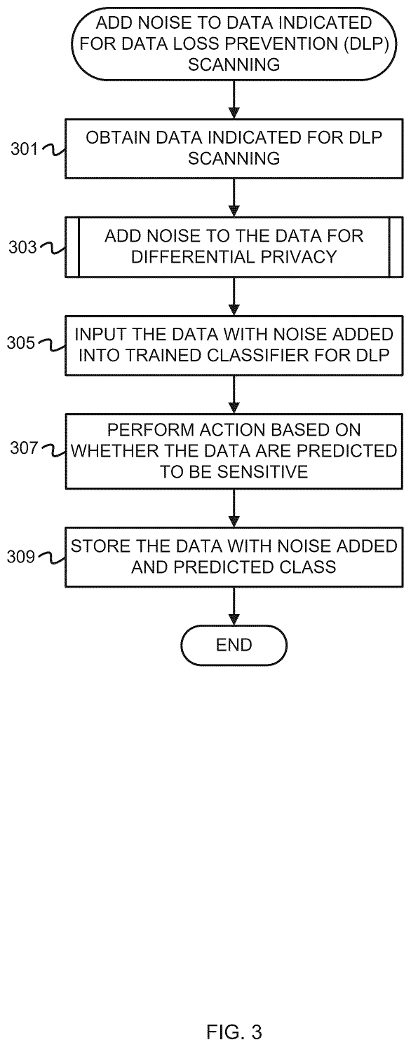

FIG. 3 is a flowchart of example operations for adding noise to data indicated for DLP scanning. The example operations are described with reference to the DLP service.

At block 301, the DLP service obtains data indicated for DLP scanning. The DLP service can obtain data submitted by an end user (e.g., data uploaded to a client device, submitted or otherwise provided to a client device for transmission over a network connection, etc.) or that was otherwise indicated for DLP scanning. To illustrate, the data may be uploaded to the DLP service, transmitted to the DLP service (e.g., to a cybersecurity appliance on which the DLP service executes), etc.

At block 303, the DLP service adds noise to embeddings of the data for differential privacy. The DLP service can invoke the noise addition service to add noise to embeddings generated from the data. For instance, block 303 can be implemented with the example operations of FIG. 2. The DLP service may generate embeddings representing the data before invoking the noise addition service (e.g., with word2vec, doc2vec, or another embedding technique). In other examples, the noise addition service invoked for noise addition can generate the embeddings before adding noise thereto.

At block 305, the DLP service inputs the embeddings with noise added into a trained classifier for DLP. The trained classifier has been trained to predict whether embeddings supplied as input correspond to sensitive information, such as PII. Examples of classifiers that can be trained to determine whether input data comprise sensitive information include artificial neural networks, random forests, support vector machines, etc. The DLP service obtains from output of the trained classifier a predicted class of the data.

At block 307, the DLP service performs an action based on whether the data are predicted to be sensitive. If the data are predicted to be sensitive, any transmission, update, access, etc. to the data can be blocked to prevent leakage of sensitive information. Otherwise, if the data are not predicted to be sensitive, then transmission, update, access, etc. of the data may be permitted. The DLP service or entity on which the DLP service executes can thus block or allow transmission, update, access, etc. of the data based on whether the DLP service predicted that the data are sensitive.

At block 309, the DLP service stores the data with noise added and its predicted class. A database or other data store that stores data with noise added and corresponding predicted classes is maintained and made accessible to the DLP service such that embeddings with noise added and their predicted classes are stored therein. These data can be used for ongoing learning of the trained classifier and/or for training of new models for DLP. Because these embeddings that are stored have had noise added thereto with the technique described herein, the risk that the original data that potentially comprise sensitive information can be recovered in the event of a breach is substantially reduced.

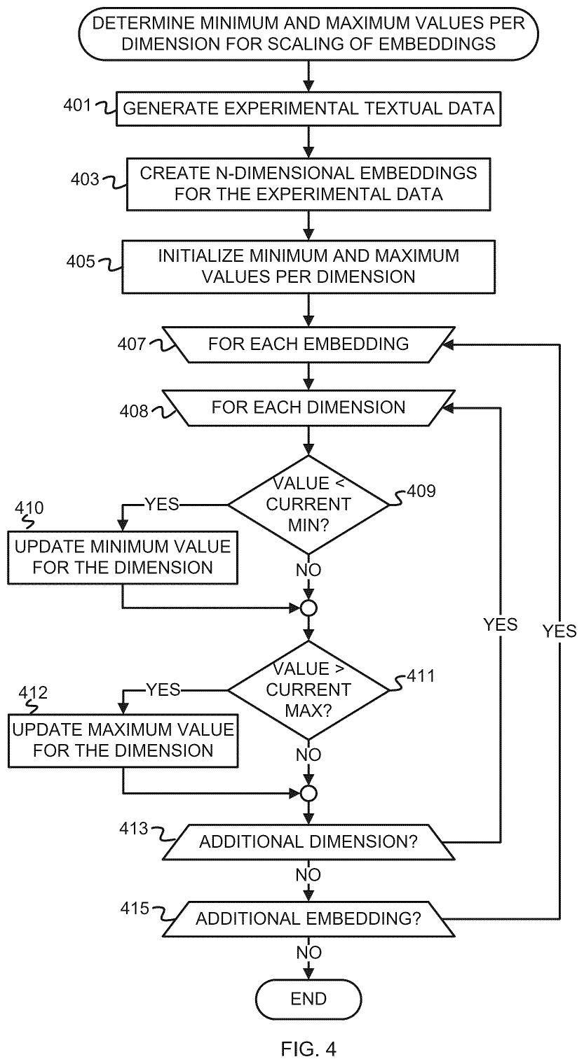

FIG. 4 is a flowchart of example operations for determining minimum and maximum values per dimension for scaling of embeddings. The example operations are described with reference to the noise addition service as an illustrative example, though an external service can determine the minimum and maximum values with which the noise addition service are configured.

At block 401, the noise addition service generates experimental textual data. The noise addition service may, for instance, prompt a language model (e.g., a large language model) to generate a set of textual data that comprises sensitive (e.g., PII) and non-sensitive data. The language model may have been adapted to the task of generating sensitive and non-sensitive data or may be prompted to generate the data as a result of zero-shot or few-shot prompting. The experimental data that results should comprise both sensitive and non-sensitive samples.

At block 403, the noise addition service creates N-dimensional embeddings for the experimental data. The noise addition service inputs each of the generated samples into an embedding model, such as a word2vec or doc2vec model. Samples comprising numerical data may be treated as text samples for the purposes of embedding generation.

At block 405, the noise addition service initializes minimum and maximum values per dimension. The minimum and maximum values for each dimension may be initialized at a default or null value. The values can be initialized in a data structure(s) that stores the values and indications of the corresponding dimensions.

At block 407, the noise addition service begins iterating over each embedding. Each of the embeddings comprises a numerical value at each of the N dimensions. At block 408, the noise addition service begins iterating over each dimension of the embedding.

At block 409, the noise addition service determines if the value at the dimension is less than the current minimum. If the value is less than the current minimum (i.e., the minimum value currently stored for the dimension), operations continue at block 410. Otherwise, operations continue at block 411.

At block 410, the noise addition service updates the minimum value for the dimension. The noise addition service updates the minimum value maintained for the dimension (e.g., in the corresponding data structure) with the value identified at the current dimension of the current embedding since this is the lowest value identified for the dimension across embeddings that have been processed thus far.

At block 411, the noise addition service determines if the value at the dimension is greater than the current maximum. If the value is greater than the current maximum (i.e., the maximum value currently stored for the dimension), operations continue at block 412. Otherwise, operations continue at block 413.

At block 412, the noise addition service updates the maximum value for the dimension. The noise addition service updates the maximum value maintained for the dimension (e.g., in the corresponding data structure) with the value at the current dimension of the current embedding since this is the greatest value identified at the dimension across embeddings that have been processed thus far.

At block 413, the noise addition service determines if there is another dimension remaining in the embedding. If there is another dimension remaining, operations continue at block 408. Otherwise, operations continue at block 415.

At block 415, the noise addition service determines if there is another embedding. If there is another embedding, operations continue at block 407. Otherwise, the minimum and maximum values for each dimension have been determined, and operations are complete. If an entity external to the noise addition service determined the minimum and maximum values, the external entity then should configure the noise addition service with the minimum and maximum values stored for each dimension (e.g., with the data structure(s) in which the values were stored).

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 211 of FIG. 2 can be performed in parallel or concurrently across scaled embeddings. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

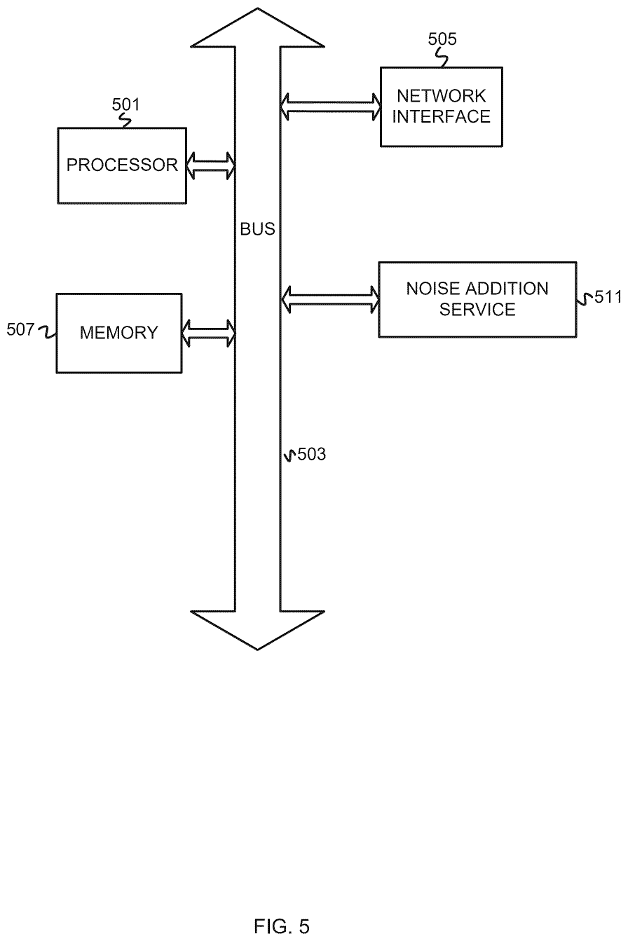

FIG. 5 depicts an example computer system with a noise addition service. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes noise addition service 511. The noise addition service 511 adds noise to data for differential privacy based on scaling N-dimensional embeddings of the data according to minimum and maximum values determined per each of the N dimensions. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
obtaining a first embedding generated for first data, wherein the first embedding comprises a plurality of values for a corresponding plurality of dimensions;
scaling each of the plurality of values of the first embedding to generate a scaled embedding,
wherein scaling each of the plurality of values comprises scaling the value relative to a minimum value and a maximum value, wherein the minimum and maximum values for each dimension were previously selected from a plurality of embeddings generated from experimental data; and
adding noise to the scaled embedding.

2. The method of claim 1, wherein adding noise to the scaled embedding comprises adding noise to the scaled embedding with the Laplace mechanism.

3. The method of claim 1, further comprising determining if the scaled embedding with added noise comprises sensitive data.

4. The method of claim 3, wherein determining if the scaled embedding with added noise comprises sensitive data comprises inputting the scaled embedding with added noise into a trained classifier, wherein the trained classifier was trained to predict whether inputs comprise sensitive data.

5. The method of claim 4, further comprising adding the scaled embedding with added noise and a label indicating whether the scaled embedding with added noise comprises sensitive data into a training dataset for ongoing learning of the trained classifier.

6. The method of claim 1, further comprising:
generating the plurality of embeddings from the experimental data; and
selecting, for each dimension of the plurality of dimensions, the minimum and maximum values identified at the dimension.

7. The method of claim 6, further comprising generating the experimental data.

8. The method of claim 7, wherein generating the experimental data comprises generating the experimental data based on prompting a language model.

9. One or more non-transitory machine-readable media having program code stored thereon, the program code comprising instructions to:
scale each of a plurality of values of an embedding of first data to generate a scaled embedding,
wherein the embedding was generated from first data and comprises a plurality of values for a corresponding plurality of dimensions,
wherein the instructions to scale each of the plurality of values comprise instructions to, for each value of the plurality of values and corresponding one of the plurality of dimensions, scale the value relative to a minimum value and a maximum value previously determined for the dimension based on experimental data; and
add noise to the scaled embedding.

10. The non-transitory machine-readable media of claim 9, wherein the instructions to add noise to the scaled embedding comprise instructions to add noise to the scaled embedding with the Laplace mechanism.

11. The non-transitory machine-readable media of claim 9, wherein the program code further comprises instructions to:
generate a plurality of embeddings from the experimental data; and
select, for each dimension of the plurality of dimensions, minimum and maximum values identified at the dimension, wherein the instructions to scale the value relative to the minimum value and the maximum value comprise instructions to scale the value relative to corresponding ones of the minimum and maximum values.

12. The non-transitory machine-readable media of claim 9, wherein the program code further comprises instructions to determine whether the scaled embedding with added noise comprises sensitive data.

13. The non-transitory machine-readable media of claim 12, wherein the instructions to determine whether the scaled embedding with added noise comprises sensitive data comprise instructions to input the scaled embedding with added noise into a trained classifier, wherein the trained classifier was trained to predict whether inputs comprise sensitive data.

14. An apparatus comprising:
a processor; and
a machine-readable medium having instructions stored thereon that are executable by the processor to cause the apparatus to,
obtain an embedding generated for first data, wherein the embedding comprises a plurality of values for a corresponding plurality of dimensions;
scale each of the plurality of values of the first embedding relative to corresponding minimum and maximum values to generate a scaled embedding, wherein each of the minimum and maximum values corresponds to one of the plurality of dimensions and was previously selected from a plurality of embeddings generated from second data; and
add noise to the scaled embedding.

15. The apparatus of claim 14, wherein the instructions executable by the processor to cause the apparatus to add noise to the scaled embedding comprise instructions executable by the processor to cause the apparatus to add noise to the scaled embedding with the Laplace mechanism.

16. The apparatus of claim 14, further comprising instructions executable by the processor to cause the apparatus to determine if the scaled embedding with added noise comprises sensitive data.

17. The apparatus of claim 16, wherein the instructions executable by the processor to cause the apparatus to determine if the scaled embedding with added noise comprises sensitive data comprise instructions executable by the processor to cause the apparatus to input the scaled embedding with added noise into a trained classifier, wherein the trained classifier was trained to predict whether inputs comprise sensitive data.

18. The apparatus of claim 17, further comprising instructions executable by the processor to cause the apparatus to add the scaled embedding with added noise and a label indicating whether the scaled embedding with added noise comprises sensitive data into a training dataset for ongoing learning of the trained classifier.

19. The apparatus of claim 14, further comprising instructions executable by the processor to cause the apparatus to:
generate the plurality of embeddings from the second data, wherein the second data comprise experimental data; and
select, for each dimension of the plurality of dimensions, a minimum value and a maximum value identified at that dimension.

20. The apparatus of claim 19, wherein the instructions executable by the processor to cause the apparatus to scale each of the plurality of values relative to the corresponding minimum and maximum values comprise instructions executable by the processor to cause the apparatus to scale, for each dimension of the plurality of dimensions, the corresponding one of the plurality of values relative to the minimum value and a maximum value identified at that dimension.
